(19) United States
(12) Patent Application Publication
(10) Pub. No.: US 2019/0157951 A1
(43) Pub. Date: May 23, 2019

(54) ROTOR, ELECTRIC MOTOR, AIR CONDITIONER, AND METHOD FOR MANUFACTURING ROTOR

(71) Applicant: Mitsubishi Electric Corporation, Tokyo (JP)

(72) Inventors: Mineo YAMAMOTO, Tokyo (JP); Tomoaki OIKAWA, Tokyo (JP); Hiroyuki ISHII, Tokyo (JP); Hiroki ASO, Tokyo (JP); Junichiro OYA, Tokyo (JP); Yuto URABE, Tokyo (JP)

(21) Appl. No.: 16/092,172

(22) PCT Filed: Jul. 1, 2016
(86) PCT No.: PCT/JP2016/069632

§ 371 Date: Oct. 8, 2018

(51) Int. Cl. H02K 15/03; H02K 1/30; H02K 1/27; B29C 45/00

(52) U.S. Cl. CPC H02K 15/03; H02K 1/30; F04D 25/06; B29C 45/0001; B29C 45/0025; H02K 1/272

(57) ABSTRACT

A rotor includes a yoke that is formed annularly and a resin magnet integrated with the yoke. The yoke includes a first inner circumferential surface, a second inner circumferential surface, and a third inner circumferential surface. The second inner circumferential surface is adjacent to the first inner circumferential surface, and has a radius larger than a radius of the first inner circumferential surface. The third inner circumferential surface is adjacent to the second inner circumferential surface, and has a radius larger than both of the radius of the first inner circumferential surface and the radius of the second inner circumferential surface.

### TECHNICAL FIELD

The present invention relates to a rotor for use in an electric motor.

### BACKGROUND ART

A rotor for an electric motor includes a rotor magnet including an annular yoke made of a thermoplastic resin and a resin magnet. formed outside the yoke in the radial direction. Patent Reference 1, for example, discloses a method for forming a resin magnet outside a yoke by injecting the resin magnet into a mold from an annular runner (doughnut-shaped runner) and a ribbed runner.

### PRIOR ART REFERENCE

### Patent Reference

Patent Reference 1: Japanese Patent Application Publication No. 2011-61938 (see FIG. 21)

### SUMMARY OF THE INVENTION

### Problem to be Solved by the Invention

When an annular yoke is formed by using the method disclosed in Patent Reference 1, for example, it is necessary to cut off a molded product formed inside the yoke (molded product formed in the doughnut-shaped runner and the ribbed runner). If the inner circumferential surface of the annular yoke is formed straight in the axial direction, damage to the inner circumferential surface of the yoke or burrs may be caused at the time of cutting off the molded product formed inside the yoke. In this case, an extra manufacturing process can arise.

It is therefore an object of the present invention to provide a rotor that simplifies a process of manufacture thereof.

### Means of Solving the Problem

A rotor according to the present invention includes: a yoke portion that is formed annularly; and a magnet portion integrated with the yoke portion, wherein the yoke portion includes a first inner circumferential surface, a second inner circumferential surface adjacent to the first inner circumferential surface and having a radius larger than a radius of the first inner circumferential surface, and a third inner circumferential surface adjacent to the second inner circumferential surface and having a radius larger than both of the radius of the first inner circumferential surface and the radius of the second inner circumferential surface.

### Effects of The Invention

According to the present invention, a rotor that simplifies a process of manufacture thereof can be provided.

### BRIEF DESCRIPTION OF THE DRAWINGS

FIG. 1 is a perspective view schematically illustrating a structure of a rotor according to a first embodiment of the present invention.

FIG. 2 is a plan view schematically illustrating a structure of a rotor magnet.

FIG. 3 is a perspective view schematically illustrating the structure of the rotor magnet.

FIG. 4 is a perspective view schematically illustrating a structure of a first end portion side of a yoke.

FIG. 5 is a perspective view schematically illustrating a structure of a second end portion side of the yoke.

FIG. 6A is a cross-sectional view of a rotor magnet taken along line C6-C6 in FIG. 2, and FIG. 6B is an enlarged view illustrating a region E1 indicated by a broken line in FIG. 6A.

FIG. 7 is a plan view schematically illustrating a structure of a mold for the yoke.

FIG. 8 is a cross-sectional view of the mold for the yoke taken along line C8-C8 in FIG. 7.

FIG. 9 is an enlarged view illustrating a region E2 indicated by a broken line in FIG. 7.

FIG. 10 is an enlarged view illustrating a region E3 indicated by a broken line in FIG. 8.

FIG. 11 is a flowchart illustrating an example of a process of manufacturing a rotor.

FIG. 12 is a plan view schematically illustrating a resin-molded product in a state where a doughnut-shaped runner, a ribbed runner, and a yoke molding portion are filled with a resin.

FIG. 13 is a perspective view schematically illustrating the resin-molded product in the state where the doughnut-shaped runner, the ribbed runner, and the yoke molding portion are filled with the resin.

FIG. 14A is a cross-sectional view of the resin-molded product taken along line C14-C14 in FIG. 12, and FIG. 14B is an enlarged view illustrating a region E4 indicated by a broken line in FIG. 14A.

FIG. 15 is a plan view schematically illustrating a structure of a mold for a resin magnet.

FIG. 16 is a cross-sectional view of the mold for the resin magnet taken along line C16-C16 in FIG. 15.

FIG. 17 is a cross-sectional view illustrating a cross section of the ribbed runner when seen in a radial direction.

FIG. 18 is a cross-sectional view illustrating a cross section of a resin magnet path portion (resin magnet path) when seen in the radial direction.

FIG. 19 is a perspective view schematically illustrating a resin-molded product in a state where the doughnut-shaped runner, the ribbed runner, and a resin magnet molding portion are filled with the resin magnet.

FIG. 20 is an exploded view of the rotor.

FIG. 21 is a cross-sectional view schematically illustrating a structure of an electric motor according to a second embodiment of the present invention.

FIG. 22 is a view schematically illustrating a configuration of an air conditioner according to a third embodiment of the present invention.

### MODE FOR CARRYING OUT THE INVENTION

### First Embodiment

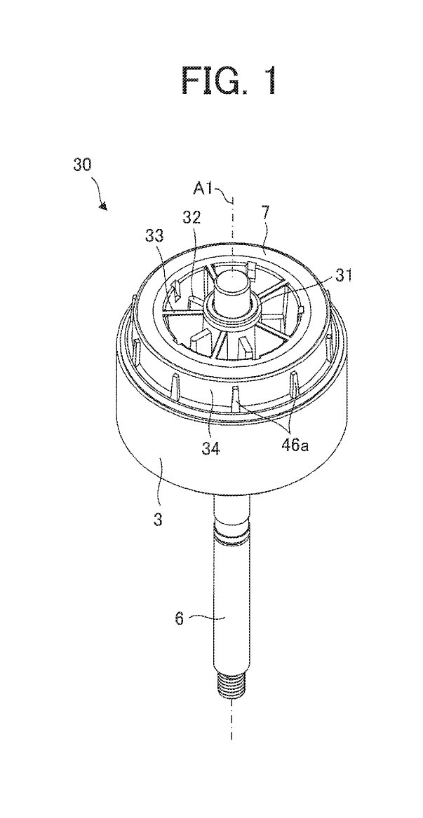

FIG. 1 is a perspective view schematically illustrating a structure of a rotor 30 according to a first embodiment of the present invention. An axis line A1 shown in FIG. 1 represents an axis line (rotation axis) of the rotor 30 (rotor magnet 3).

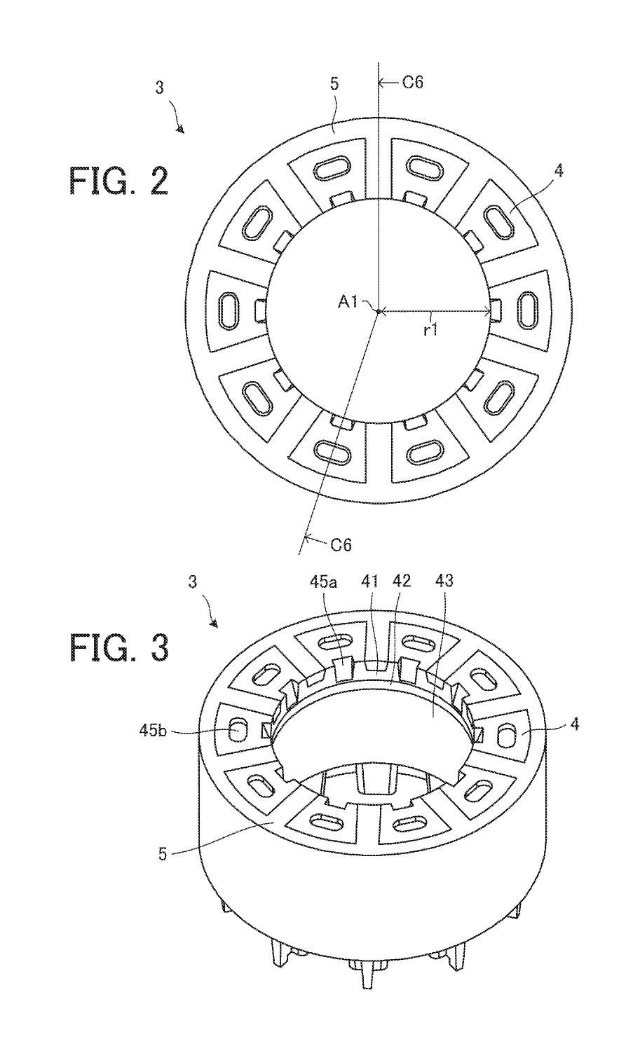

FIG. 2 is a plan view schematically illustrating a structure of the rotor magnet 3. A radius r1 shown in FIG. 2 represents a radius of a first inner circumferential surface 41 described later.

FIG. 3 is a perspective view schematically illustrating a structure of the rotor magnet 3.

The rotor 30 includes the rotor magnet 3, a shaft 6, and a sensor magnet 7. In addition, in this embodiment, a first cylindrical resin portion 31 (also simply referred to as a “resin portion”) is formed at the outer circumferential surface of the shaft 6. The shape of the first cylindrical resin portion 31 is not limited to a hollow cylindrical shape. Projections 32 and ribs 33 are alternately formed on the outer circumferential surface of the first cylindrical resin portion 31. A second cylindrical resin portion 34 (also simply referred to as a “resin portion”) to fix the sensor magnet 7 is formed on an inner side and an outer side of the sensor magnet 7. The shape of the second cylindrical resin portion 34 is not limited to a hollow cylindrical shape. Each of the first cylindrical resin portion 31 and the second cylindrical resin portion 34 is made of a thermoplastic resin such as a polybutylene terephthalate (PET) resin.

The plurality of projections 32 are formed at regular intervals in the circumferential direction. The plurality of ribs 33 are formed at regular intervals in the circumferential direction. The outer circumferential surface of the shaft 6 is provided with knurls for preventing displacement.

The rotor magnet 3, the shaft 6, and the sensor magnet 7 are integrated by the first cylindrical resin portion 31, the ribs 33, and the second cylindrical resin portion 34. Rotation torque of the rotor magnet 3 is transferred to the shaft 6 through protrusions 46a, the second cylindrical resin portion 34, the ribs 33, and the first cylindrical resin portion 31.

The second cylindrical resin portion 34 is formed to cover notches 45a, recesses 48, and bases 46 of a yoke 4 described later. Accordingly, displacement of the yoke 4 relative to the shaft 6 in the circumferential direction can be prevented so that the torque can be easily transferred.

The inner side (inner circumferential surface) of the sensor magnet 7 is formed like a step-shaped. The second cylindrical resin portion 34 is formed on the step-shaped inner circumferential surface, and thus, the sensor magnet 7 is fixed in the axial direction of the rotor 30 (rotor magnet 3) (hereinafter simply referred to as the “axial direction”). Only the inner circumferential surface of the sensor magnet 7 on the outer side in the axial direction may be formed like a step-shaped. The shape of the inner circumferential surface of the sensor magnet 7 may be another shape such that the sensor magnet 7 is fixed by the second cylindrical resin portion 34 in the axial direction.

The rotor magnet 3 includes the yoke 4 serving as a yoke portion and a resin magnet 5 serving as a magnet portion. The yoke 4 is formed annularly. The resin magnet 5 is integrated with the yoke 4 by integral molding outside the yoke 4 (on the outer circumferential surface 49) in the radial direction of the rotor 30 (rotor magnet 3) (hereinafter simply referred to as the “radial direction”). The yoke 4 can be obtained by molding into an annular shape with injection molding, for example. The resin magnet 5 can be obtained by integrally molding with the yoke 4 at the outer circumferential surface 49 of the yoke 4 by injection molding, for example.

The yoke 4 is, for example, a soft magnetic material or a thermoplastic resin (e.g., nylon) containing ferrite (ferrite magnet).

The resin magnet 5 is a thermoplastic resin containing, as a main component, a rare earth magnet (rare earth magnet powder) such as a samarium-iron-nitrogen (Sm—Fe—N)-based magnet (magnet powder), for example. However, the resin magnet 5 may be a thermoplastic resin containing, as a main component, a rare earth magnet (rare earth magnet powder) such as a neodymium-iron-boron (Nd—Fe—B)-based magnet (magnet powder).

The rotor 30 according to this embodiment has ten magnetic poles. The number of magnetic poles of the rotor 30, however, is not limited to ten, and. only needs to be an even number.

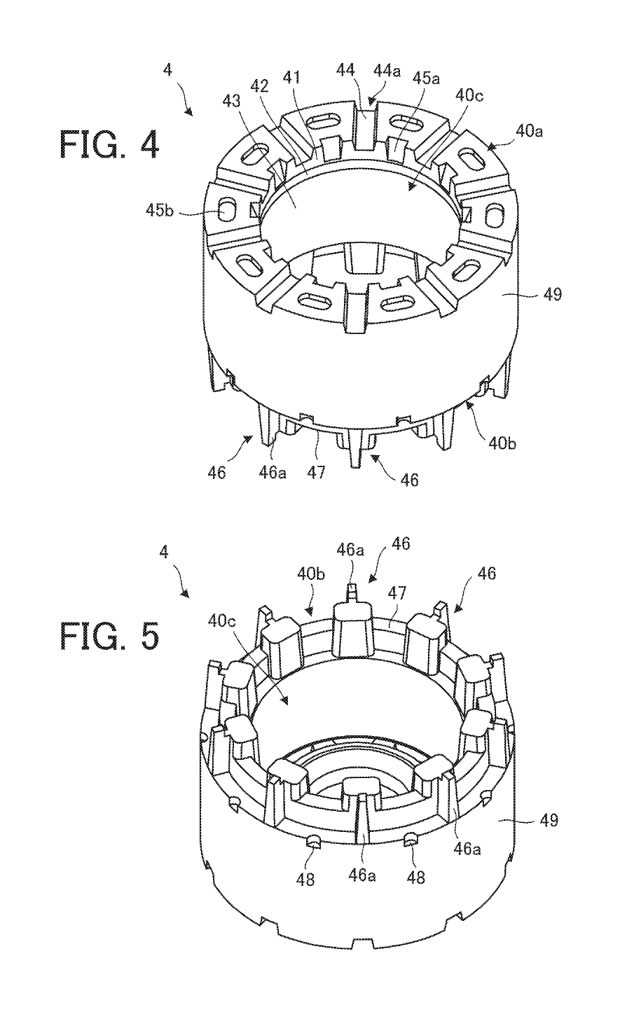

FIG. 4 is a perspective view schematic all illustrating a structure of a first end portion 40a side of the yoke 4.

FIG. 5 is a perspective view schematically illustrating a structure of a second end portion 40b side of the yoke 4.

The yoke 4 includes the first end portion 40a, the second end portion 40b, a hollow portion 40c, the first inner circumferential surface 41, a second inner circumferential surface 42, a third inner circumferential surface 43, a plurality of resin magnet path portions 44, the plurality of notches 45a, the plurality of recesses 45b, the plurality of bases 46, coupling portions 47 coupling the bases 46, the plurality of recesses 48, and the outer circumferential surface 49.

The second end portion 40b faces the first end portion 40a in the axial direction.

In the yoke 4 (e.g., the soft magnetic material or ferrite contained in the yoke 4), an easy axis of magnetization is oriented to have polar anisotropy. In this embodiment, the outer circumference (the cross-sectional shape of the outer circumferential surface 49) of the yoke 4 is a complete circle. The outer circumference of the yoke 4 may have a waved shape.

The resin magnet path portions 44 are formed in the first end portion 40a. Each of the resin magnet path portions 44 forms a resin magnet path 44a (resin magnet injection paths) through which a material for the resin magnet 5 (hereinafter also referred to as a “resin magnet”) passes. Each of the resin magnet path. portions 44 is formed at a magnetic pole position. That is, in this embodiment, ten resin magnet path. portions 44 are formed in the yoke 4. The resin magnet path portion 44 passes through the annular first end portion 40a from the inner circumferential surface to the outer circumferential surface. The resin magnet path portion 44 (resin magnet paths 44a) is formed so as to gradually widen toward the first end portion 40a.

Each of the notches 45a is formed in the first end portion 40a. The notch 45a is formed between adjacent magnetic poles. That is, the notch 45a is formed between adjacent resin magnet path portions 44. Each of the notches 45a is formed like a tapered shape so as to gradually widen toward the first end portion 40a. Each of the notches 45a is formed so that its axis corresponds to the axis of the inner circumferential surface of the yoke 4. Accordingly, when the rotor magnet 3 and the shaft 6 are combined using a mold. and a thermoplastic resin, the concentricity and phases of the rotor magnet 3 and the shaft 6 can be appropriately set.

The bases 46 are formed on the second end portion 40b. The bases 46 support the sensor magnet 7 in such a manner that the sensor magnet 7 is separated from the second end portion 40b. Each of the bases 46 is formed at a position facing the magnetic pole.

The bases 46 include the protrusions 46a supporting the outer circumferential surface of the sensor magnet 7. The protrusions 46a can be used for positioning in molding the rotor magnet 3. The protrusions 46a can also be used for positioning in magnetization of the rotor 30.

The plurality of bases 46 are integrated by the coupling portions 47 formed to be lower than the bases 46. Thus, strength of the bases 46 is maintained by the coupling portions 47. The coupling portions 47 are preferably formed at the center between the inner circumferential side and the outer circumferential side on the second end portion 40b. Accordingly, the thickness of the second cylindrical resin portion 34 formed around the coupling portions can be made uniform so that a conspicuous sink mark can be prevented.

The recesses 48 (recesses for restricting displacement) are formed in the second end portion 40b. Specifically, each of the recesses 48 is formed at the center position between adjacent ones of the protrusions 46a. A cross section of the recess 48 is semicircular in shape when seen in the axial direction. When the yoke 4 and the resin magnet 5 are integrally molded, the recesses 48 are filled with the resin magnet 5. Accordingly, the recesses 48 have the function of transferring torque to the resin magnet 5 and also have the function of preventing displacement of the resin magnet 5 (displacement relative to the yoke 4) in the circumferential direction. The recesses 48 effectively functions especially when the outer circumference of the yoke 4 has a complete circle shape.

The resin magnet path portions 44 are also filled with the resin magnet 5. Thus, the resin magnet path portions 44 have functions similar to those of the recesses 48. That is, displacement of the resin magnet 5 in the circumferential direction (displacement relative to the yoke 4) can be prevented.

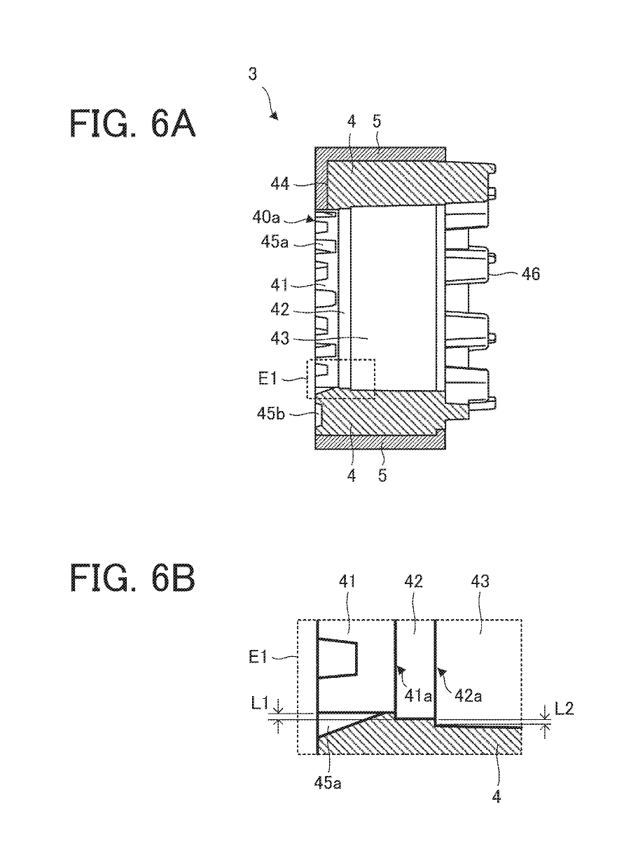

FIG. 6A is a cross-sectional view of the rotor magnet 3 taken along line C6-C6 in FIG. 2. FIG. 6B is an enlarged view illustrating a region El indicated by a broken line in FIG. 6A.

As illustrated in FIGS. 6A and 6B, the yoke 4 includes the first inner circumferential surface 41, the second inner circumferential surface 42, and the third inner circumferential surface 43. The yoke 4 may additionally have another inner circumferential surface (e.g., a fourth inner circumferential surface).

The first inner circumferential surface 41 is an inner circumferential surface formed at one end (an end on the first end portion 40a side) of the yoke 4 in the axial direction. The first inner circumferential surface 41 is adjacent to the second inner circumferential surface 42 in the axial direction. In this embodiment, among the plurality of inner circumferential surfaces of the yoke 4, a radius r1 of the first inner circumferential surface 41 is the smallest radius. That is, the first inner circumferential surface 41 has a radius smaller than those of the second inner circumferential surface 42 and the third inner circumferential surface 43. The first inner circumferential surface 41 is preferably a surface extending in parallel with the axial direction. The first inner circumferential surface 41 has openings of the resin magnet path portions 44 (entrances of the resin magnet paths 44a).

The second inner circumferential surface 42 is adjacent to the first inner circumferential surface 41 and the third inner circumferential surface 43 in the axial direction. That is, the second inner circumferential surface 42 is formed between the first inner circumferential surface 41 and the third inner circumferential surface 43. The second inner circumferential surface 42 has a radius larger than the radius r1 of the first inner circumferential surface 41. The second inner circumferential surface 42 has a radius smaller than the radius of the third inner circumferential surface 43.

The third inner circumferential surface 43 is adjacent to the second inner circumferential surface 42 in the axial direction. The third inner circumferential surface 43 has a radius lager than both of the radius r1 of the first inner circumferential surface 41 and the radius of the second inner circumferential surface 42. The third inner circumferential surface 43 is formed. like a tapered shape so as to gradually widen toward the first end portion 40a (in the direction opposite to the first inner circumferential surface 41 and the second inner circumferential surface 42). In this embodiment, the third inner circumferential surface 43 is longer than both of the first inner circumferential surface 41 and the second inner circumferential surface 42 in the axial direction.

The yoke 4 includes a first step 41a formed between the first inner circumferential surface 41 and the second inner circumferential surface 42. The yoke 4 also includes a second. step 42a formed between the second inner circumferential surface 42 and the third inner circumferential surface 43. That is, a step difference L1 (first step difference) of the first step 41a is a difference between the radius r1 of the first inner circumferential surface 41 and the radius of the second inner circumferential surface 42, and a step difference L2 (second step difference) of the second step 42a is a difference between the radius of the second inner circumferential surface 42 and the radius of the third inner circumferential surface 43. Each of the step difference L1 of the first step 41a and the step difference L2 of the second step 42a is preferably 0.1 mm or more in the axial direction.

In this embodiment, the rotor magnet 3 is formed of the yoke 4 and the resin magnet 5. The rotor magnet 3, however, is not limited to the example described in this embodiment. For example, a single structure to which the structure of the yoke 4 described. above is applied may be formed as the rotor magnet 3.

A method for manufacturing the rotor 30 will now be described.

First, a structure of a mold 400 for forming The yoke 4 will be described.

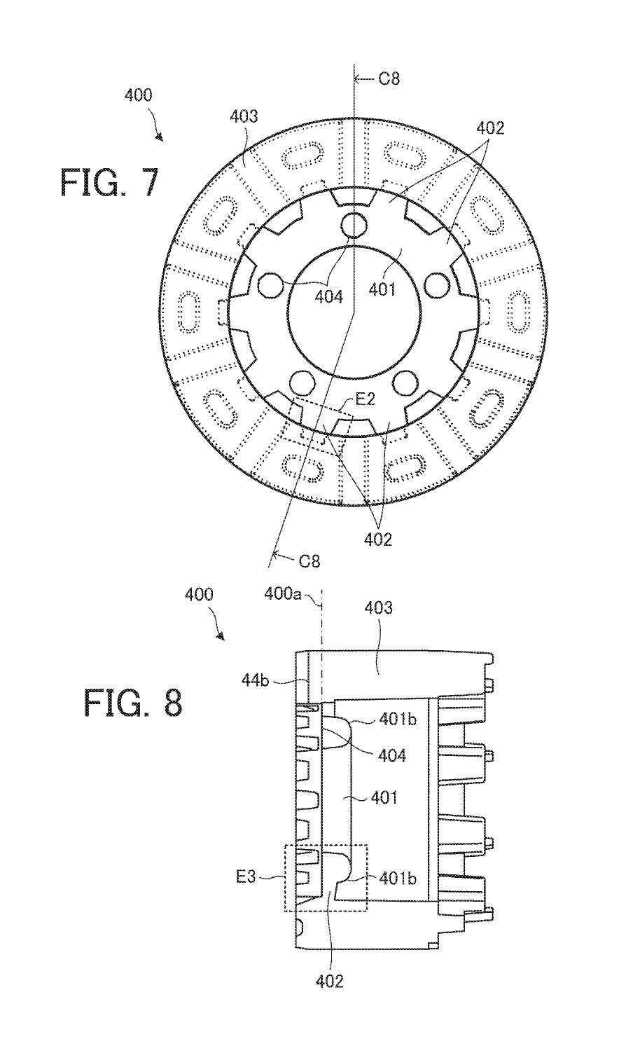

FIG. 7 is a plan view schematically illustrating the structure of the mold 400 for the yoke 4.

FIG. 8 is a cross-sectional view of the mold 400 taken along line C8-C8 in FIG. 7.

The mold 400 includes a yoke runner (also simply referred to as a “runner”) into which a thermoplastic resin is injected and. a yoke molding part 403 (also referred to as a “molding part”) to mold a thermoplastic resin. into the yoke 4. The yoke runner includes a doughnut-shaped runner 401 (annular runner) as a first runner portion and a plurality of ribbed. runners 402 as second runner portions.

As illustrated in FIG. 8, the doughnut-shaped runner 401 and the ribbed runners 402 are placed in a position where it is axially away from the position where a bottom surface 44b of the resin magnet path portion 44 is formed. The doughnut-shaped runner 401 gradually decreases in size toward the second end portion 40b.

A corner 401b of the doughnut-shaped runner 401 in the axial direction is rounded. Accordingly, it is possible to reduce resistance when a molded product (resin-molded product formed in the doughnut-shaped runner 401) is removed from. the mold 400.

As illustrated in FIG. 7, the doughnut-shaped runner 401 includes a plurality of gate ports 404. in this embodiment, the number of the gate ports 404 is half of the number of magnetic poles of the rotor magnet 3. The gate ports 404 are arranged at regular intervals in the circumferential direction. of the doughnut-shaped runner 401 and are also arranged at regular intervals with respect to the ribbed runners 402.

The first end portion 40a of the yoke 4 is formed at a fixed side of the mold 400, and the second end portion 40b of the yoke 4 is formed at a movable side of the mold 400. In this embodiment, a core of the mold 400 is divided by a division plane 400a (parting line).

The mold 400 is preferably designed such that the positions of the bases 46 coincide with positions where weld lines occur. Since the bases 46 are thick enough to maintain strength, strength of the yoke 4 can be maintained even when weld lines are generated. In addition, the mold 400 is designed such that the bases 46 are formed. at positions facing magnetic poles. Accordingly, the thermoplastic resin as a material for the yoke 4 can be injected uniformly in the circumferential direction so that an oriented magnetic field can be uniformly formed.

As illustrated in FIG. 7, the plurality of ribbed runners 402 radiate from the axis line of the yoke 4 (axis line A1 of the rotor 30) as the center. In other words, the ribbed runners 402 extend outward in the radial direction from the doughnut-shaped runner 401 and couple the doughnut-shaped runner 401 to the yoke molding portion 403. Each of the ribbed runners 402 is disposed at a position between magnetic poles. That is, the number of the ribbed runners 402 is equal to the number of magnetic poles of the rotor magnet 3.

Each of the ribbed runners 402 is disposed at a position facing the second inner circumferential surface 42. Thus, the boundary between the ribbed runners 402 and the yoke molding portion 403 corresponds to the second inner circumferential surface 42 (specifically a part of the second inner circumferential surface 42 formed in the circumferential direction). In this embodiment, the position of the first step 41a in the axial direction is determined according to the arrangement of the ribbed runners 402.

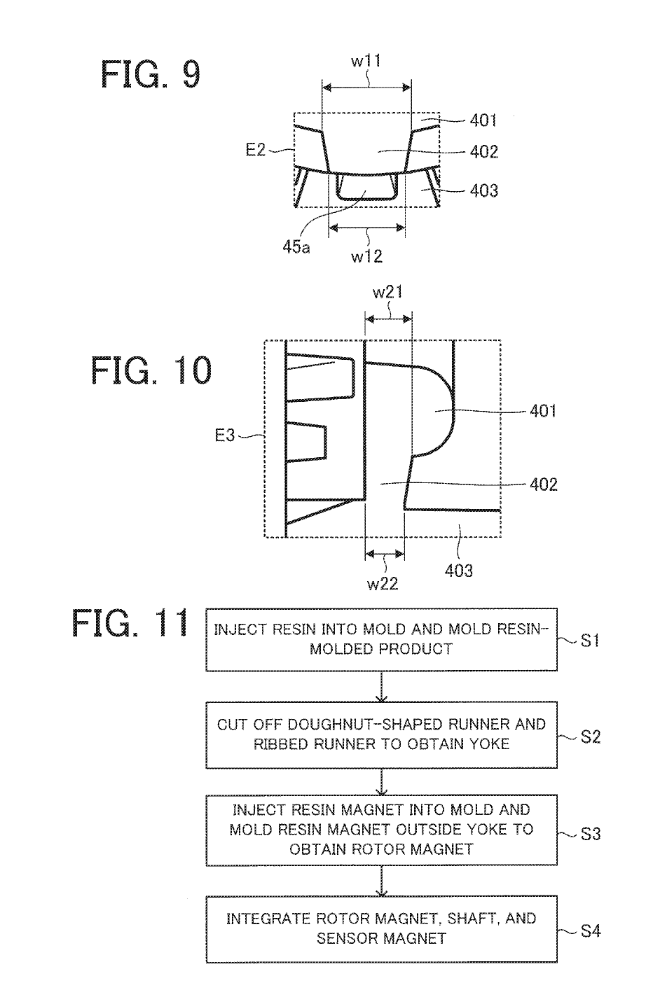

FIG. 9 is an enlarged view illustrating a region E2 indicated by a broken line in FIG. 7.

FIG. 10 is an enlarged view illustrating a region E3 indicated by a broken line in FIG. 8.

As illustrated in FIG. 9, a width w12 of a radially outer side of the ribbed runner 402 is smaller than a width w11 of a radially inner side. In addition, as illustrated in FIG. 10, a thickness w22 of the radially outer side of the ribbed runner 402 is smaller than. a thickness w21 of the radially inner side. That is, as illustrated in FIGS. 9 and 10, the width and thickness of the ribbed runner 402 gradually decrease in a radially outer direction (i.e., toward the yoke molding portion 403) . At least one of the width and thickness of the ribbed runner 402 may gradually decrease in the radially outer direction. Accordingly, a molded product formed in the doughnut-shaped runner 401 and the ribbed runners 402 can be easily cut off after molding of the yoke 4. In particular, the molded product is easily cut off at the front ends of the ribbed runners 402, and thus, it is possible to reduce damage caused by occurrence of burrs on the inner circumferential surface of the yoke 4 (a yoke body 403a described later) and scraping part of the inner circumferential surface,

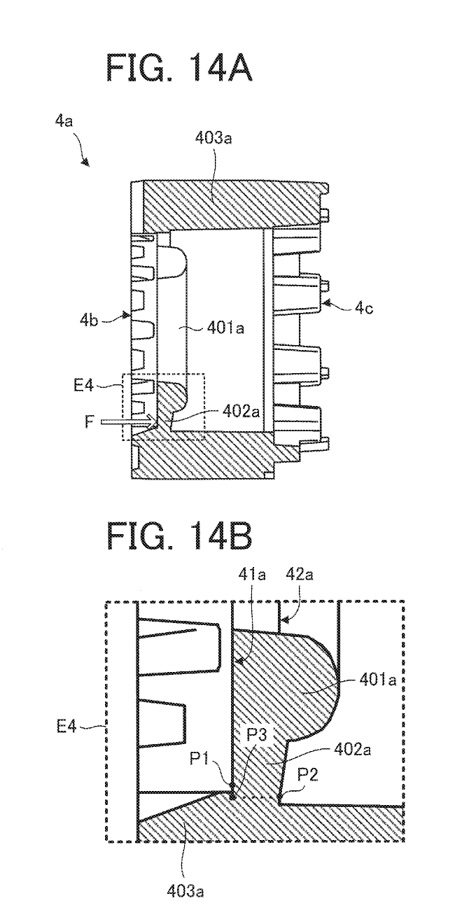

For example, in a case where the thickness w21 and the thickness w22 of the ribbed runners 402 are the same as each other, when the molded product formed in the ribbed runners 402 is cut off, the molded product formed in the ribbed runners 402 is cut off at any position between a power point P1 (see FIG. 14B) and the inner circumferential surface of the yoke 4, and therefore burrs are easily caused. Thus, the thickness w22 of the ribbed runners 402 is preferably smaller than the thickness w21, as described above.

The first step 41a of the yoke 4 is formed with the mold 400 between the first inner circumferential surface 41 and the second inner circumferential surface 42, The second step 42a of the yoke 4 is formed with the mold 400 between the second inner circumferential surface 42 and the third inner circumferential surface 43. Each of the step differences L1 and L2 formed on the first step 41a and the second step 42a, respectively, with the mold 400 are preferably 0.1 mm or more in the radial direction.

FIG. 11 is a flowchart illustrating an example of a process of manufacturing the rotor 30.

With reference to FIG. 11, a method for manufacturing the rotor 30 (including the step of forming the yoke 4) will now be described.

Steps S1 and S2 in which the yoke 4 is molded by injecting a thermoplastic resin into the mold 400 described above are performed.

A material for the yoke 4 is a thermoplastic resin (hereinafter also referred to as a “resin”) containing a soft magnetic material or ferrite (ferrite magnet) as a main component.

In step S1, the resin is injected into the doughnut-shaped runner 401 through the gate ports 404. After the injection of the resin into the doughnut-shaped runner 401 through the gate ports 404, the flow direction bends 90° and the flow is divided into two. Then, the resin passes through the ribbed runners 402 so that the yoke molding portion 403 is filled with the resin.

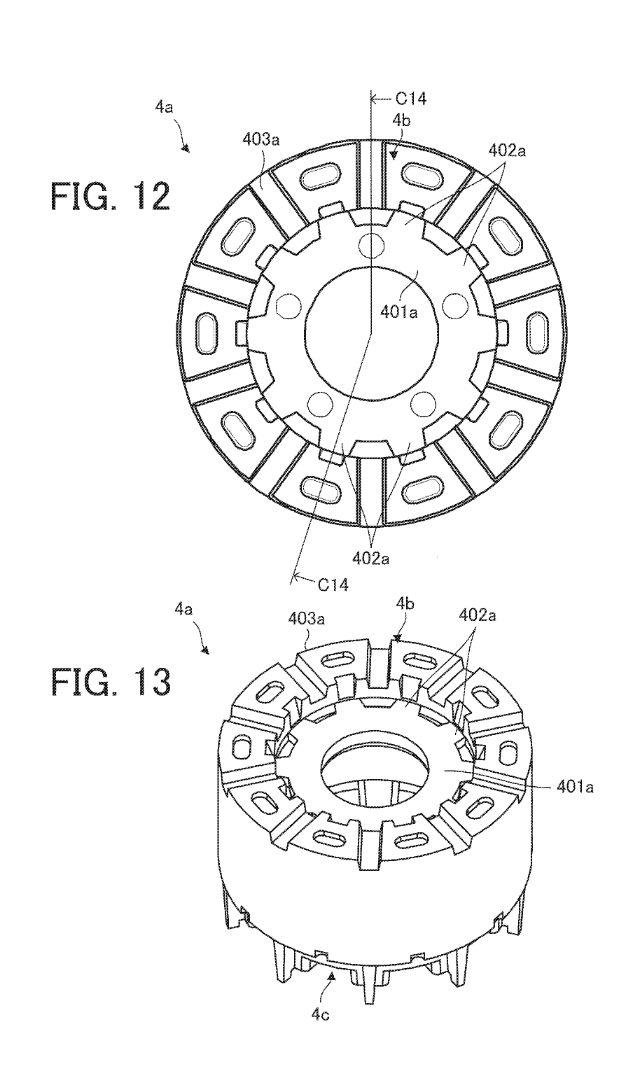

FIG. 12 is a plan view schematically illustrating a resin-molded product 4a in a state where the doughnut-shaped runner 401, the ribbed runners 402, and the yoke molding portion 403 are filled with the resin.

FIG. 13 is a perspective view schematically illustrating the resin-molded product 4a in the state where the doughnut-shaped runner 401, the ribbed runners 402, and the yoke molding portion 403 are filled with the resin.

By filling the doughnut-shaped runner 401, the ribbed runners 402, and the yoke molding part 403 of the mold 400 with the resin, the resin-molded product 4a ,also simply referred to as a “molded product”) composed of a doughnut-shaped runner part 401a as a first resin part, ribbed runner parts 402a as second resin parts, and a yoke body 403a as a third resin part is formed. The yoke body 403a corresponds to the yoke 4.

The doughnut-shaped runner 401, the doughnut-shaped runner part 401a and the ribbed runner parts 402a formed in the ribbed runners 402 are also collectively referred to as a “first portion.” The yoke body 403a formed in the yoke molding part 403 is also collectively referred to as a “second portion.”

With the molding using the mold 400, the yoke body 403a is formed like an annular shape, and the first inner circumferential surface 41, the second inner circumferential surface 42 adjacent to the first inner circumferential surface 41 and the third inner circumferential surface 43 in the axial direction, and the third inner circumferential surface 43 adjacent to the second inner circumferential surface 42 in the axial direction are formed on the inner side (inner circumferential surface) of the yoke body 403a. The second inner circumferential surface 42 is formed to have a radius larger than the radius r1 of the first inner circumferential surface 41 and smaller than the radius of the third inner circumferential surface 43. The third inner circumferential surface 43 is formed to have a radius larger than both of the radius r1 of the first inner circumferential surface 41 and the radius of the second inner circumferential surface 42.

Accordingly, the first step 41a and the second step 42a are formed on the inner side (inner circumferential surface) of the yoke body 403a with the mold 400.

Next, step S2 is performed, where the doughnut-shaped runner part 401a and the ribbed runner parts 402a (i.e., the first part) are separated from the yoke body 403a (i.e., the second part).

FIG. 14A is a cross-sectional view of the resin-molded product. 4a taken along line C14-C14 in FIG. 12. FIG. 14B is an enlarged view illustrating a region E4 indicated by a broken line in FIG. 14A.

The doughnut-shaped runner part 401a and the ribbed runner parts 402a of the resin-molded product 4a are cut off by push cutting with a jig. For example, the doughnut-shaped runner part 401a and the ribbed runner parts 402a are cut off by push cutting from the first end portion 4b (corresponding to the first end portion 40a of the yoke 4) side of the resin-molded product 4a. For example, when a force F is applied to the doughnut-shaped runner part 401a and the ribbed runner parts 402a (e.g., the power point P1) with the technique of cutting off the doughnut-shaped runner part 401a and the ribbed runner parts 402a from the first end portion 4b side, a position of the front end of the ribbed runner part 402a on the second end portion 4c (corresponding to the second end portion 40b of the yoke 4) side in the radial direction can be set as a fulcrum P2, and a position of the front end of the ribbed runner part 402a on the first end portion 4b side in the radial direction can be set as an action point P3.

That is, since the first step 41a and the second step 42a are formed on the inner side (inner circumferential surface) of the yoke body 403a with the mold 400, the fulcrum P2 and the action point P3 can be set on the inner side (inner circumferential surface) of the yoke body 403a at the time of push. cutting. Accordingly, the doughnut-shaped runner part 401a and the ribbed runner parts 402a can be easily cut off. In addition, it is possible to reduce damage caused by scraping part of the inner circumferential surface of the yoke body 403a (yoke 4) at the time of push cutting.

Each of the step difference L1 of the first step 41a and the step difference L2 of the second step 42a is 0.1 mm or more so that functions of the fulcrum. P2 and the action point P3 can be sufficiently obtained easily. Thus, damage to the inner circumferential surface of the yoke body 403a (yoke 4) can be reduced.

The third inner circumferential surface 43 of the yoke body 403a (yoke 4) is formed like a tapered shape so as to gradually widen toward the second end portion 4c (in the direction opposite to the first inner circumferential surface 41 and the second inner circumferential surface 42) by using a core of the movable side of the mold 400. By forming the third inner circumferential surface 43 to be the tapered shape, it is possible to reduce hitting the yoke body when the doughnut-shaped runner part 401a and the ribbed runner parts 402a are removed from the yoke body 403a (yoke 4) and to reduce damage to the inner circumferential surface of the yoke body 403a (yoke 4).

The first inner circumferential surface 41 is preferably formed to extend in parallel with the axial direction. In other words, the first inner circumferential surface 41 is preferably formed in parallel with the axis line A1. Accordingly, when a resin magnet is injected into the resin. magnet path portions 44 (resin magnet paths 44a), the first inner circumferential surface 41 can be brought into close contact with the core of the mold. (mold 500 described later) for the resin magnet 5. Thus, it is possible to prevent leakage of the resin magnet into a gap between the inner circumferential surface of the yoke 4 and the core of the mold 500.

As described above, through the step of separating the doughnut-shaped. runner part 401a and the ribbed runner parts 402a (i.e., the first part) from the yoke body 403a (i.e., the second part), the annular yoke 4 can be obtained.

Thereafter, orientation in the yoke 4 is performed. Specifically, strong magnets are arranged outside the yoke 4 in the radial direction, and the easy axis of magnetization is oriented so that the yoke 4 (e.g., a soft magnetic material or ferrite contained in the yoke 4) has polar anisotropy.

Through the foregoing steps, the yoke 4 illustrated in FIGS. 4 and 5 are obtained, and steps S1 and S2 of forming the yoke 4 are completed.

Subsequently, the step of forming the resin magnet 5, that is, step S3 of making the rotor magnet 3, is performed.

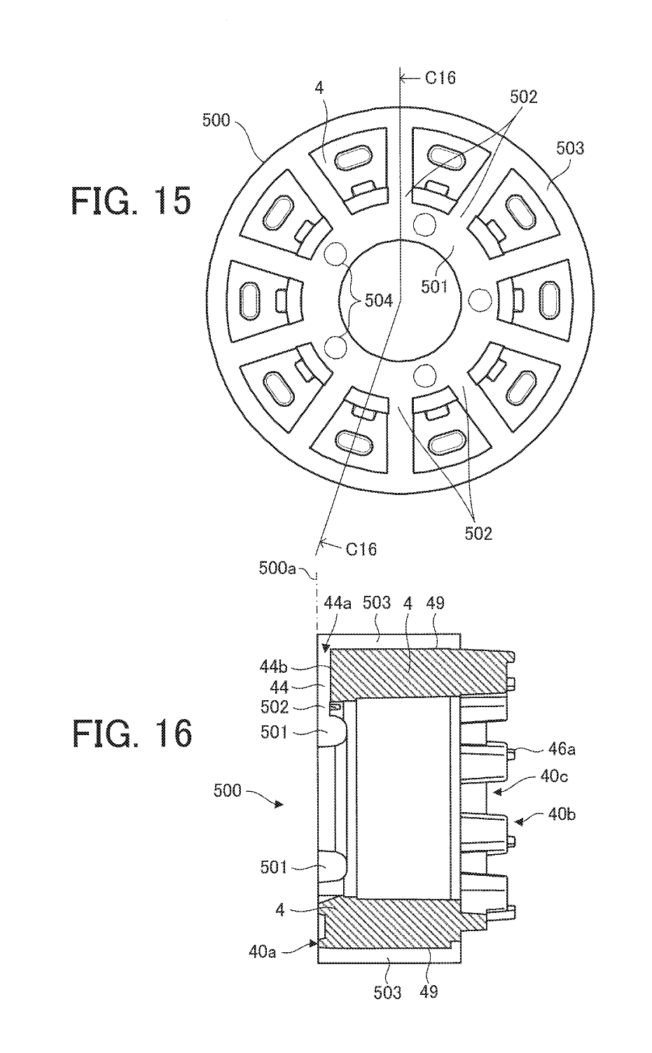

FIG. 15 is a plan view schematically illustrating a structure of the mold 500 for the resin magnet 5.

FIG. 16 is a cross-sectional view of the mold 500 taken along line C16-C16 in FIG. 15.

The mold 500 includes a doughnut-shaped runner 501 (annular runner), a plurality of ribbed runners 502, and a resin magnet molding portion 503. The resin magnet 5 is molded outside the yoke 4 in the radial direction by injection molding, and is integrated with the yoke 4.

As illustrated in FIG. 16, the doughnut-shaped runner 501 and the ribbed runners 502 are arranged on the first end portion 40a side such that the ribbed runners 502 and the resin. magnet paths 44a (resin magnet path portions 44) are at the same height in the axial direction.

The ribbed runners 502 radiate from the axis line of the yoke 4 (axis line A1 of the rotor 30) as the center. In other words, the ribbed runners 502 extend outward in the radial direction from the doughnut-shaped runner 501 and couple the doughnut-shaped runner 501 to the resin magnet paths 44a (resin magnet path portions 44). The number of the ribbed runners 502 is equal to the number of magnetic poles of the rotor magnet 3.

As illustrated in FIG, 15, the doughnut-shaped runner 501 includes a plurality of gate ports 504. In this embodiment, the number of the gate ports 504 is half of the number of magnetic poles of the rotor magnet 3. The gate ports 504 are arranged at regular intervals in the circumferential direction of the doughnut-shaped runner 501 and are also arranged at regular intervals with respect to the ribbed runners 502.

The resin magnet molding portion 503 are formed outside the yoke 4 in the radial direction so as to face the outer circumferential surface 49 of the yoke 4. The resin magnet melding portion 503 forms the outer circumferential surface of the resin magnet 5 (outer circumferential surface of the rotor magnet 3).

The core of the movable side of the mold 500 is inserted into the hollow portion 40c of the yoke 4 so that the yoke 4 is fixed to the movable side of the mold 500. At this time, the protrusions 46a of the yoke 4 are fitted into recesses of the mold 500 so that the yoke 4 can be positioned in the circumferential direction. The positioning in the circumferential direction determines the position to an external magnet for generating an oriented magnetic field of the rotor magnet 3. As illustrated in FIG. 16, in this state, a front end position 500a of the core of the mold 500 inserted. in the hollow portion 40c of the yoke 4 is adjusted to the position of the first end portion 40a.

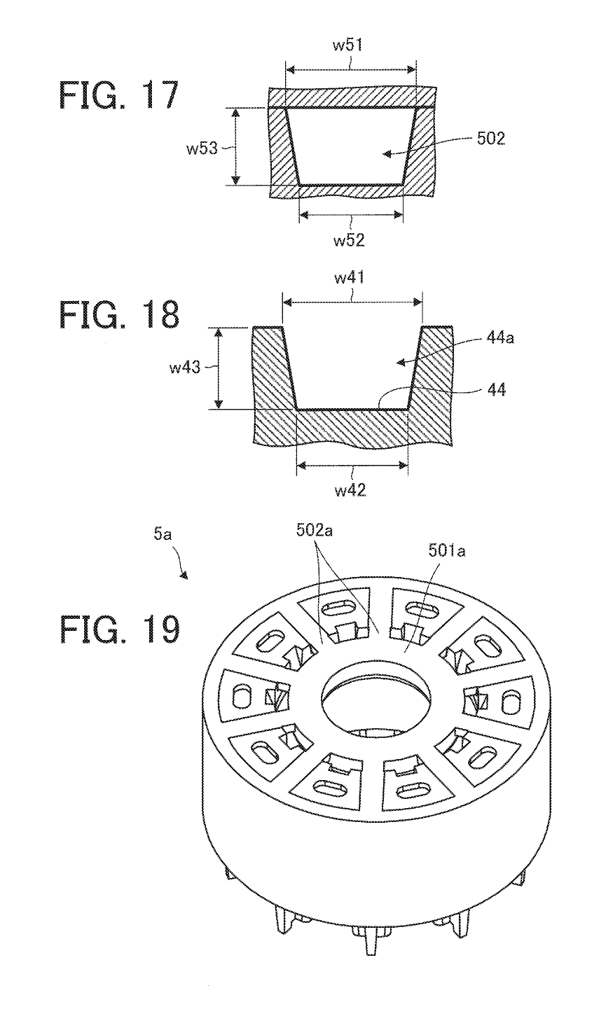

FIG. 17 is a cross-sectional view illustrating a cross section of the ribbed runner 502 when seen in the radial direction.

FIG. 18 is a cross-sectional view illustrating a cross section of the resin magnet path portion 44 (resin magnet path 44a) when seen in the radial direction.

A width w51 of the ribbed runner 502, a width w52 of the bottom surface of the ribbed runner 502, and a depth w53 of the ribbed runner 502 on the first end portion 40a side are respectively equal to or slightly smaller than a width w41 of the resin magnet path 44a, a width w42 of the bottom surface of the resin magnet path 44a, and a depth w43 of the resin magnet. path 44a on the first end portion 40a side. Accordingly, the resin magnet that is a material for the resin magnet 5 can be easily injected from the ribbed runners 502 into the resin magnet paths 44a. In addition, even when the resin magnet is injected at high temperature under high pressure, it is possible to prevent the yoke 4 (especially the resin magnet path portions 44) from melting.

When the resin magnet is injected, the core of the mold 500 is preferably in close contact with the first inner circumferential surface 41 so as to prevent the resin magnet from the ribbed runners 502 from leaking into a gap between the inner circumferential surface of the yoke 4 and the core of the mold 500.

A step of injecting the resin magnet (i.e., a material for the resin magnet 5) into the doughnut-shaped runner 501 through each of the gate ports 504 of the mold 500 described above is performed.

The material for the resin magnet 5 is a thermoplastic resin containing, as a main component, a rare earth magnet (rare earth magnet powder) such as a samarium-iron-nitrogen (Sm—Fe—N)-based magnet (magnet powder) (where such a thermoplastic resin will be hereinafter referred to as a “resin magnet”). However, the material for the resin magnet 5 may be a thermoplastic resin containing, as a main component, a rare earth magnet (rare earth magnet powder) such as a neodymium-iron-boron (Nd—Fe—B)-based magnet (magnet powder).

The resin magnet is injected into the doughnut-shaped runner 501 through each of the gate ports 504, and the flow direction bends 90° and the flow is divided into two. The resin magnet then passes through the ribbed runners 502 and the resin magnet paths 44a, and then the resin magnet molding portion 503 is filled with the resin magnet.

When the resin magnet molding portion 503 is filled with the resin magnet, the resin magnet 5 is formed. Since the recesses 48 of the yoke 4 are also filled with the resin magnet, displacement of the resin magnet. 5 in the circumferential direction (displacement. relative to the yoke 4) can be prevented. The recesses 48 effectively function especially when the outer circumference of the yoke 4 has a complete circle shape.

The resin magnet path portions 44 (resin magnet paths 44a) are also filled with the resin magnet 5, and thus displacement of the resin magnet 5 in the circumferential direction (displacement relative to the yoke 4) can be prevented. The yoke 4 is held by the resin magnet 5 with which the recesses 48 of the yoke 4 and the resin magnet path portions 44 (resin magnet paths 44a) are filled, and thus displacement in the axial direction is prevented.

FIG. 19 is a perspective view schematically illustrating a resin-molded product 5a in a state where the doughnut-shaped runner 501, the ribbed runners 502, and the resin magnet molding portion 503 are filled with the resin magnet.

As illustrated in FIG. 19, by filling the mold 500 with the resin magnet, the resin-molded product 5a is formed. A doughnut-shaped runner part 501a formed by the doughnut-shaped runner 501 and the ribbed runner part 502a formed by the ribbed runners 502 in the resin-molded product 5a are cut off so that the resin magnet 5 integrated with the yoke 4 is formed.

Thereafter, orientation in the resin magnet 5 is performed. Specifically, a strong magnet is disposed outside the resin magnet 5 in the radial direction, and the easy axis of magnetization is oriented with the magnet so that the resin magnet 5 (magnet powder contained in the resin magnet 5) has polar anisotropy.

Through the foregoing steps, the rotor magnet 3 illustrated in FIGS. 2 and 3 is obtained, and step S3 of making the rotor magnet 3 is completed.

Next, step S4 of integrating the rotor magnet 3, the shaft 6, and the sensor magnet 7 will be described below.

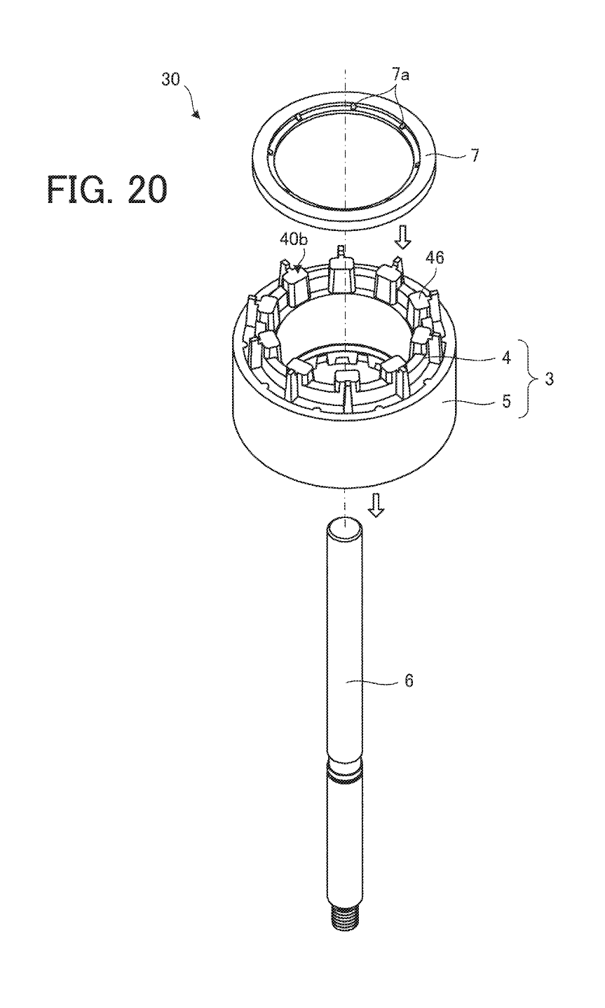

FIG. 20 is an exploded view of the rotor 30.

The rotor magnet 3, the shaft 6, and the sensor magnet 7 are integrated by injection molding so that the rotor 30 is obtained. For example, the first end portion 40a side of the yoke 4 is incorporated in a lower part of a mold placed in a vertical molder, and the notches 45a of the yoke 4 are fitted in the lower part of the mold. At this time, projections of the mold are pushed against the notches 45a in such a manner that the axis of the rotor magnet 3 (especially, the outer circumferential surface of the rotor magnet 3) corresponds to the axis of the shaft 6.

Thereafter, the shaft 6 is disposed inside the rotor magnet 3, and the sensor magnet 7 is disposed on the bases 46 of the yoke 4. That is, the sensor magnet 7 is supported by the bases 46. In this state, the mold is closed, and injection molding is performed using a thermoplastic resin such as a PBT resin.

In the injection molding, a portion of the rotor magnet 3 except the outer circumferential surface is supported by the mold so that occurrence of burrs on the outer circumferential surface of the rotor magnet 3 can be prevented. Thus, the injection molding can be performed easily.

In the injection molding, the thermoplastic resin is injected from the second end portion 40b side of the yoke 4 (from a position that is away from the sensor magnet 7) into resin injection parts, and thereby, a first cylindrical resin portion 31, a plurality of projections 32, and a plurality of ribs 33 are formed outside the shaft 6 (see FIG. 1). The plurality of projections 32 are formed by filling the resin injection parts with the thermoplastic resin. That is, each of the projections 32 corresponds to the resin injection part. By injecting the thermoplastic resin from the resin injection parts, the first cylindrical resin portion 31 can be quickly filled with the thermoplastic resin so that strength of weld portions of the first cylindrical resin. portion 31 can be enhanced.

The number of the resin injection parts (i.e., the projections 32) is half of the number of magnetic poles of the rotor magnet 3. The projections 32 and the ribs 33 are formed to be alternately arranged in the circumferential direction. The plurality of projections 32 are formed at regular intervals in the circumferential direction. Similarly, the ribs 33 are arranged at regular intervals in the circumferential direction.

In addition, by the injection molding, the thermoplastic resin passes through gaps between the coupling portions 47 and the sensor magnet 7 (between adjacent ones of the bases 46), and thus the space surrounding the bases 46 is filled with the thermoplastic resin. Accordingly, the second cylindrical resin portion 34 is formed between the sensor magnet 7 and the protrusions 46a of the bases 46 (FIG. 1). In addition, a plurality of protrusions 46a are exposed from the second cylindrical resin portion 34.

The thermoplastic resin is injected to cover the recesses 48 and the bases 46 of the yoke 4, and thus the thermoplastic resin is caught by the recesses 48 and the bases 46 even when mold shrinkage of the thermoplastic resin (e.g., the second. cylindrical resin portion 34 and the ribs 33) inward in the radial direction is caused. Accordingly, occurrence of a clearance can be prevented so that strength of the rotor magnet 3 can be enhanced. Consequently, no additional structure is necessary for enhancing strength of the rotor magnet 3, and thus, cost reduction and noise reduction of an electric motor 100 can be achieved.

Reduction of the quantity of the ribs 33 can reduce costs. Thus, the number, thickness, and length in the radial direction of the ribs 33 can be appropriately designed in consideration of strength for withstanding intermittent operation and torque of the electric motor 100. Transmission exciting force can be adjusted by adjusting the number and shape of the ribs 33, and thus, noise (noise reduction) of the electric motor 100 can be controlled.

In addition, the step-shaped inner side (inner circumferential surface) of the sensor magnet 7 is filled with the thermoplastic resin. Accordingly, the sensor magnet 7 is fixed in the axial direction. At this time, the space surrounding the plurality of ribs 7a formed on the inner circumferential surface of the sensor magnet 7 is also filled with the thermoplastic resin. Thus, displacement relative to the rotor magnet 3 in the circumferential direction can be prevented.

Through the foregoing steps, the rotor 30 illustrated in FIG. 1 is obtained, and the process of manufacturing the rotor 30 is completed.

Advantages of the rotor 30 according to the first embodiment will now be described.

The rotor 30 according to the first embodiment includes the first inner circumferential surface 41, the second inner circumferential surface 42 adjacent to the first inner circumferential surface 41 and the third inner circumferential surface 43 in the axial direction, and the third inner circumferential surface 43 adjacent to the second inner circumferential surface 42 in the axial direction. The second inner circumferential surface 42 has a radius larger than the radius r1 of the first inner circumferential surface 41 and smaller than the radius of the third inner circumferential surface 43. The third inner circumferential surface 43 has a radius lager than both of the radius r1 of the first inner circumferential surface 41 and the radius of the second inner circumferential surface 42. The first step 41a and the second step 42a are formed on the inner side (inner circumferential surface) of the yoke 4. Accordingly, in the process of manufacturing the rotor 30 (specifically the yoke 4), the doughnut-shaped runner part 401a and the ribbed runner parts 402a can be easily cut off, and. thus damage to the inner circumferential surface of the yoke 4 (yoke body 403a) and occurrence of burrs can be reduced. Therefore, steps such as a step of repairing a damaged portion of a burr removal step can be reduced, and the process of manufacturing the rotor 30 can be simplified.

Since each of the step difference L1 of the first step 41a and the step difference L2 of the second step 42a is 0.1 mm or more, functions of the fulcrum P2 and the action point P3 are sufficiently obtained. Thus, damage to the inner circumferential surface of the yoke body 403a (yoke 4) can be reduced.

Since the first inner circumferential surface 41 is a surface extending in parallel with the axial direction, when the resin magnet is injected into the resin magnet path portions 44 (resin magnet paths 44a), the first inner circumferential surface 41 and the core of the mold 500 can be brought into close contact with each other. Thus, it is possible to prevent the resin magnet from leaking into a gap between the inner circumferential surface of the yoke 4 and the core of the mold 500.

Since the third inner circumferential surface 43 is formed like a tapered shape, the doughnut-shaped runner part 401a and the ribbed runner parts 402a can be easily separated from. the yoke body 403a (yoke 4). Thus, damage to the inner circumferential surface of the yoke body 403a (yoke 4) can be reduced.

Next, advantages of the method for manufacturing the rotor 30 according to the first embodiment will be described below.

With the method for manufacturing the rotor 30 according to the first embodiment, the first inner circumferential surface 41, the second inner circumferential surface 42 adjacent to the first inner circumferential surface 41 and the third inner circumferential surface 43 in the axial direction, and the third inner circumferential surface 43 adjacent to the second inner circumferential surface 42 in the axial direction are formed on the inner side (inner circumferential surface) of the yoke 4 with the mold 400. The second inner circumferential surface 42 is formed to have a radius larger than the radius r1 of the first inner circumferential surface 41 and smaller than the radius of the third inner circumferential surface 43. The third inner circumferential surface 43 is formed to have a radius larger than both of the radius r1 of the first inner circumferential surface 41 and the radius of the second inner circumferential surface 42. The first inner circumferential surface 41, the second inner circumferential surface 42, and the third inner circumferential surface 43 are formed, and thus the first step 41a and the second step 42a are formed on the inner side (inner circumferential surface) of the yoke 4. Accordingly, in the process of manufacturing the rotor 30 (specifically the yoke 4) , the doughnut-shaped runner part 401a and the ribbed runner parts 402a can be easily cut off, and thus damage to the inner circumferential surface of the yoke 4 (yoke body 403a) and occurrence of burrs can be reduced. Therefore, steps such as a step of repairing a damaged portion or a burr removal step can be reduced, and the process of manufacturing the rotor 30 can be simplified.

Specifically, the second. step 42a is formed with the mold 400 so that the fulcrum P2 and the action point P3 in cutting off the doughnut-shaped runner part 401a and the ribbed runner parts 402a can be set. Thus, the doughnut-shaped runner part 401a and the ribbed runner parts 402a can be easily cut off, and damage to the inner circumferential surface of the yoke 4 (yoke body 403a) can be reduced. The yoke body 403a (yoke 4) is formed such that each of the step difference L1 of the first step 41a and the step difference L2 of the second step 42a is 0.1 mm or more so that functions of the fulcrum P2 and the action point P3 can be sufficiently obtained. Thus, damage to the inner circumferential surface of the yoke body 403a (yoke 4) can be reduced.

In forming the resin magnet 5, a flow of the resin magnet is changed in the doughnut-shaped runner 501. Accordingly, as compared to a method of chancing a flow of the resin magnet in the resin magnet path portion 44, damage to the yoke 4 during formation of the resin magnet 5 (during injection of the resin magnet) can be prevented.

For example, in a method of directly injecting the resin magnet into the outside of the yoke in the radial direction, is necessary to form small gate ports and to reduce molding pressure in order to form a thin resin magnet. On the other hand, in this embodiment, in forming the resin magnet 5, the resin magnet is injected using the doughnut-shaped runner 501. Accordingly, the diameter of the gate port 504 can be set at any size, as compared to the method of directly injecting the resin magnet into the outside of the yoke 4 in the radial direction.

Since the number of the gate ports 504 is half of the number of magnetic poles of the rotor magnet 3, the amount of runners can be reduced with respect to the molded product (rotor magnet 3), and thus, manufacturing costs can be reduced. In addition, since the amount of runners can be reduced, a reuse ratio is reduced in a case of reusing the runners, and degradation of properties (e.g., mechanical strength) of the molded product (resin magnet 5) can be suppressed.

Since the number of ribbed runners 502 is equal to the number of magnetic poles of the rotor magnet 3, the amount of injection of the resin magnet can be made uniform among magnetic poles, and thus, an oriented magnetic field can be made uniform.

Since the yoke 4 includes the resin magnet path. portions 44 (resin magnet paths 44a), paths of the resin magnet for forming the resin magnet 3 can be simplified.

### Second Embodiment

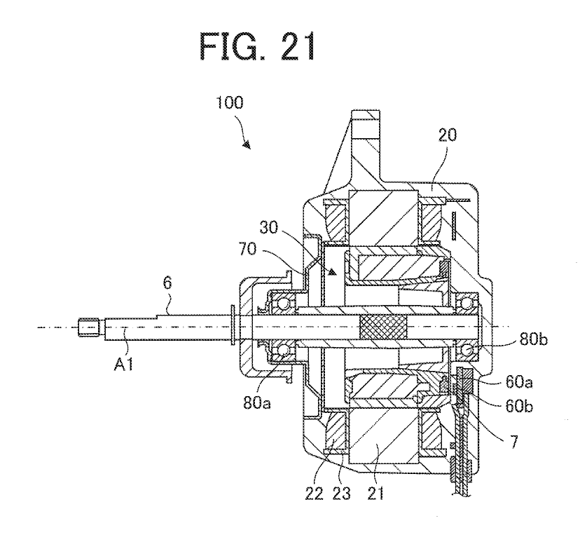

FIG. 21 is a cross-sectional view schematically illustrating a structure of an electric motor 100 according to a second embodiment of the present invention.

The electric motor 100 includes a stator 20, a rotor 30, a circuit board 60a, a magnetic sensor 60b for detecting a rotation. position of the sensor magnet 7, a bracket 70, and. bearings 80a and 80b.

The rotor 30 of the electric motor 100 is the rotor (e.g., the rotor 30 illustrated in FIG. 1) described in the first embodiment. The rotation axis of the rotor 30 coincides with the axis line A1.

Electronic components such as a control circuit and the magnetic sensor 60b are mounted on the circuit board 60a.

The magnetic sensor 60b detects a rotation position of the sensor magnet 7, thereby detecting a rotation position of the rotor 30.

The stator 20 includes a stator core 21, a coil 22, and an insulator 23. The stator core 21 is formed by, for example, stacking a plurality of electromagnetic steel sheets. The stator core 21 is formed annularly. The coil 22 is insulated by the insulator 23. In this embodiment, each of the coil 22 and the insulator 23 is made of a thermoplastic resin such as PBT.

The rotor 30 is inserted inside the stator 20 with a gap in between. The bracket 70 is press fitted in an opening at a load side (load side of the electric motor 100) of the stator 20. The shaft 6 is inserted in the bearing 80a, and the bearing 80a is fixed at the load side of the stator 20. Similarly, the shaft 6 is inserted in the bearing 80b, and the bearing 80b is fixed at a counter-load side of the stator 20. Thus, the rotor 30 is rotatably supported by the bearings 80a and 80b.

With the electric motor 100 according to the second embodiment, the electric motor 100 includes the rotor 30 according to the first embodiment, and thus advantages similar to those described in the first embodiment can be obtained.

### Third Embodiment

An air conditioner 10 according to a third embodiment of the present invention will be described.

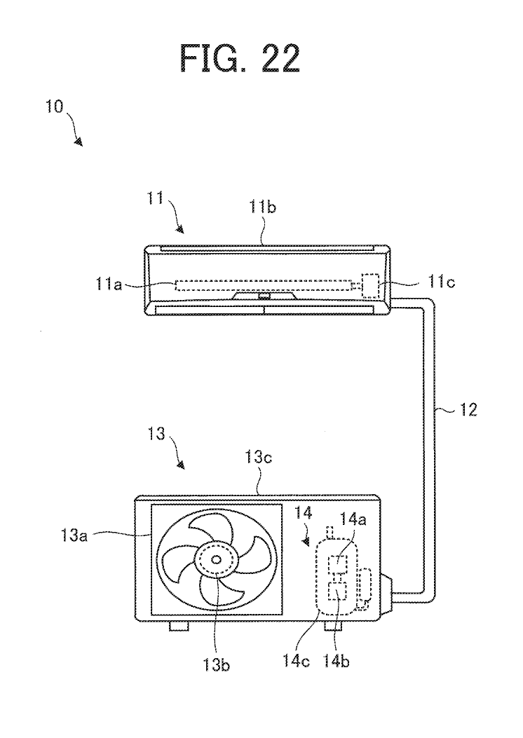

FIG. 22 is a view schematically illustrating a configuration of the air conditioner 10 according to the third embodiment of the present invention.

The air conditioner 10 according to the third embodiment includes an indoor unit 11, a refrigerant pipe 12, and the outdoor unit 13 connected to the indoor unit 11 by the refrigerant pipe 12.

The indoor unit 11 includes, for example, a fan 11a (indoor unit fan) and a housing 11b covering the fan 11a. The fan 11a includes, for example, an electric motor 11c and a blade driven by the electric motor 11c.

The outdoor unit 13 includes, for example, a fan 13a (outdoor unit fan), a compressor 14, a heat exchanger (not shown), and a housing 13c covering these components. The fan 13a includes, for example, an electric motor 13b and a blade driven by the electric motor 13b. The compressor 14 includes an electric motor 14a (e.g., the electric motor 100 described in the second embodiment), a compression mechanism 14b (e.g., a refrigerant circuit) driven by the electric motor 14a, and a housing 14c housing the electric motor 14a and the compression mechanism 14b.

In the air conditioner 10 according to the third embodiment, at least one of the indoor unit 11 and the outdoor unit 13 includes the electric motor 100 described in the second. embodiment. Specifically, as a driving source of the fan, the electric motor 100 described in the second embodiment is applied to at least one of the electric motors 11c and 13b. In addition, the electric motor 100 described in the second embodiment may be used as the electric motor 14a of the compressor 14.

The air conditioner 10 can, for example, perform operations such as a cooling operation of sending cold air and a heating operation of sending warm air from the indoor unit 11. In the indoor unit 11, the electric motor 11c is a driving source for driving the fan 11a. The fan 11a can send conditioned air.

In the air conditioner 10 according to the third embodiment, the electric motor 100 described in the second embodiment is applied to at least one of the electric motors 11c and 13b, and thus, advantages similar to those described in the first and second embodiments can be obtained.

The electric motor 100 described in the second embodiment can be mounted on equipment including a driving source, such as a ventilator, a home appliance, or a machine tool, in addition to the air conditioner 10.

Features of the embodiments described above can be combined with each other as appropriate.

### DESCRIPTION OF REFERENCE CHARACTERS

3 rotor magnet,

4 yoke (yoke portion),

4a, 5a resin-molded product,

5 resin magnet (magnet portion),

6 shaft,

7 sensor magnet,

10 air conditioner,

11 indoor unit,

11a, 13a fan,

11b, 13c, 14c housing,

11c, 13b, 14a, 100 electric motor,

12 refrigerant pipe,

13 outdoor unit,

14 compressor,

20 stator,

21 stator core,

22 coil,

23 insulator,

30 rotor,

31 first cylindrical resin portion,

32 projection,

33 rib,

34 second cylindrical resin portion,

40a first end portion,

40b second end portion,

40c hollow portion,

41 first inner circumferential surface,

41a first step,

42 second inner circumferential surface,

42a second step,

43 third inner circumferential surface,

44 resin magnet path portion,

44a resin magnet path,

45a notch,

45b recess,

46 base,

46a protrusion,

47 coupling portion,

48 recess,

49 outer circumferential surface,

60a circuit board,

60b magnetic sensor,

70 bracket,

80a, 80b bearing,

400, 500 mold,

401, 501 doughnut-shaped runner,

401a, 501a doughnut-shaped runner part,

402, 502 ribbed runner,

402a, 502a ribbed runner part,

403 yoke molding portion,

403a yoke body,

404, 504 gate port,

503 resin magnet molding portion.

1. A rotor comprising:
a yoke portion that is formed annularly; and
a magnet portion integrated with the yoke portion,
wherein
the yoke portion includes
a first inner circumferential surface,
a second inner circumferential surface adjacent to the first inner circumferential surface and having a radius larger than a radius of the first inner circumferential surface, and
a third inner circumferential surface adjacent to the second inner circumferential surface and having a radius larger than both of the radius of the first inner circumferential surface and the radius of the second inner circumferential surface.

2. The rotor according to claim 1, wherein the yoke portion includes a first step formed between the first inner circumferential surface and the second inner circumferential surface.

3. The rotor according to claim 2, wherein the yoke portion includes a second step formed between the second inner circumferential surface and the third inner circumferential surface.

4. The rotor according to claim 1, wherein a difference between the radius of the first inner circumferential surface and the radius of the second inner circumferential surface is 0.1 mm or more in a radial direction of the rotor.

5. The rotor according to claim 1, wherein a difference between the radius of the second inner circumferential surface and the radius of the third inner circumferential surface is 0.1 mm or more in a radial direction of the rotor.

6. The rotor according to claim 1, wherein the first inner circumferential surface is a surface extending in parallel with an axial direction of the rotor.

7. The rotor according to claim 1, wherein the first inner circumferential surface is an inner circumferential surface formed on an end portion of the yoke portion in an axial direction of the rotor.

8. The rotor according to claim 1, wherein the third inner circumferential surface is formed like a tapered shape so as to gradually widen in a direction opposite to the second inner circumferential surface.

9. The rotor according to claim 1, wherein the yoke portion is a thermoplastic resin containing a soft magnetic material as a main component.

10. The rotor according to claim 1, wherein the yoke portion is a thermoplastic resin containing a ferrite magnet as a main component.

11. The rotor according to claim 1, wherein the magnet portion is integrated with the yoke portion outside the yoke portion in a radial direction of the rotor.

12. The rotor according to claim 1, wherein the magnet portion is a thermoplastic resin containing a rare earth magnet as a main component.

13. An electric motor comprising the rotor according to claim 1.

14. An air conditioner comprising:
an indoor unit; and
an outdoor unit connected to the indoor unit, wherein
at least one of the indoor unit and the outdoor unit includes the electric motor according to claim 13.

15. A method for manufacturing a rotor including an annular yoke portion having a first inner circumferential surface, a second inner circumferential surface adjacent to the first inner circumferential surface, and a third inner circumferential surface adjacent to the second inner circumferential surface, the method comprising the steps of:
forming the first inner circumferential surface, the second inner circumferential surface having a radius larger than a radius of the first inner circumferential surface, and the third inner circumferential surface having a radius larger than both of the radius of the first inner circumferential surface and the radius of the second inner circumferential surface, by injecting a thermoplastic resin into a mold including a runner into which the thermoplastic resin is injected and a molding portion to mold the thermoplastic resin into the yoke portion; and
separating a first part formed in the runner from a second part formed in the molding portion.
